(19) United States
(12) Patent Application Publication
(10) Pub. No.: US 2006/0232561 A1
(43) Pub. Date: Oct. 19, 2006

(54) Electronic writing apparatus

(75) Inventor: Chen-Sung Liao, Taichung City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Disk King Technology Co., Ltd.

(21) Appl. No.: 11/108,483

(22) Filed: Apr. 18, 2005

(51) Int. Cl. G09G 5/00

(52) U.S. Cl. 345/173

(57) ABSTRACT

An electronic writing apparatus includes a transparent writing board mounted in front of a display surface of a display unit and having a writing surface distal from the display surface of the display unit. The writing board permits transmission of a light signal with a wavelength within a range from 400 nm to 700 nm therethrough. A triangulation device includes a position sensing module mounted on the writing surface of the writing board and coupled to the display unit. The position sensing module outputs an output signal associated with contact position information of a stylus on the writing surface to the display unit. The display unit generates an output image corresponding to writing trace of the stylus on the writing surface based on the output signal received from the position sensing module.

### BACKGROUND OF THE INVENTION

1. Field of the Invention

The invention relates to an electronic writing apparatus, more particularly to an electronic writing apparatus that can generate an output image corresponding to writing trace of a stylus.

2. Description of the Related Art

FIG. 1 illustrates a conventional electronic writing board that includes a whiteboard 11, an electronic writing pen 12, and a receiver module 13. The electronic writing pen 12 has a stylus with ink, and is capable of transmitting a writing signal. The receiver module 13 receives the writing signal, and generates contact position information of the stylus on the whiteboard 11 associated with the writing signal received thereby.

FIG. 2 illustrates a conventional electronic writing apparatus that includes a display unit 21, a touch pen 22, and a resistive touch pad 211. The display unit 21 can be a liquid crystal display, a plasma display or an electronic projection display, and has a display surface. The resistive touchpad 211 is mounted on the display surface of the display unit 21 for generating control signals by contacting the touch pen 22 therewith. The control signals are associated with contact position information of the touch pen 22 on the resistive touchpad 211. The resistive touchpad 211 is made of a resistive membrane, which is expensive to fabricate and which can hardly be formed in large sizes. Furthermore, the resistive membrane of the resistive touchpad 211 adversely affects the luminosity of the display unit 21.

### SUMMARY OF THE INVENTION

Therefore, the object of the present invention is to provide an electronic writing apparatus that can generate an output image corresponding to writing trace of a stylus and that can eliminate the aforesaid drawbacks of the prior art.

According to the present invention, an electronic writing apparatus comprises:

a display unit having a display surface;

a transparent writing board mounted in front of the display surface of the display unit and having a writing surface distal from the display surface of the display unit, the writing board permitting transmission of a light signal with a wavelength within a range from 400 nm to 700 nm therethrough; and

a triangulation device including
a stylus, and
a position sensing module mounted on the writing surface of the writing board and coupled to the display unit, the position sensing module outputting an output signal associated with contact position information of the stylus on the writing surface to the display unit, the display unit generating an output image corresponding to writing trace of the stylus on the writing surface based on the output signal received from the position sensing module.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic front view of a conventional electronic writing board;

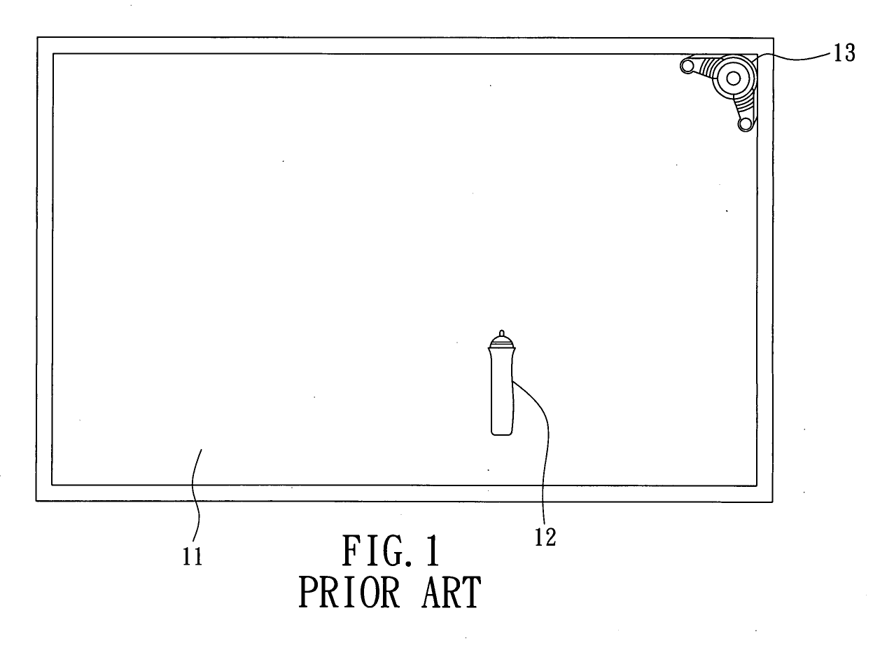

FIG. 2 is a schematic front view of a conventional electronic writing apparatus;

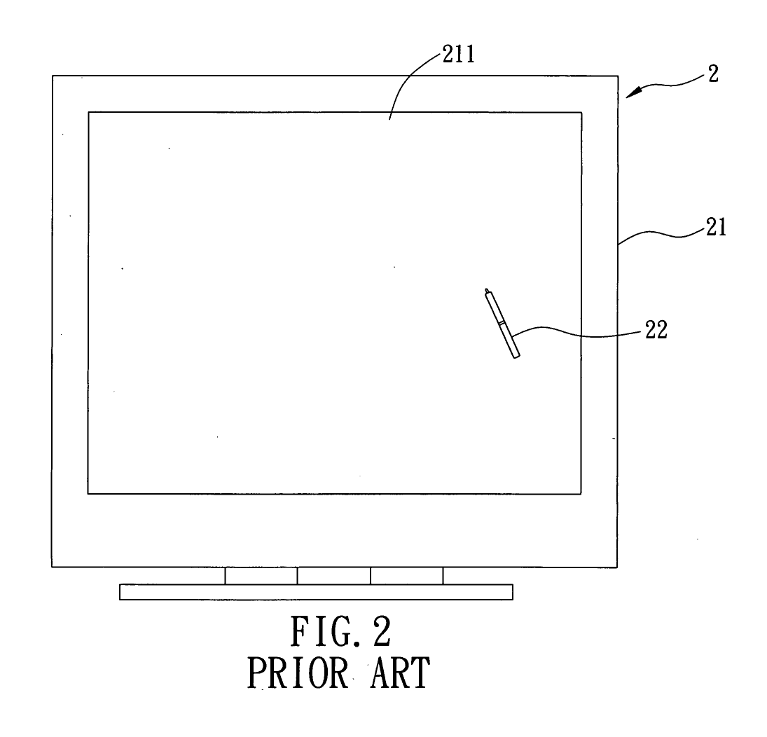

FIG. 3 is a partly exploded perspective view showing the preferred embodiment of an electronic writing apparatus according to the present invention;

FIG. 3a is an exploded perspective view showing a transparent writing board and a position sensing module of the preferred embodiment;

FIG. 4 is an assembled perspective view showing the preferred embodiment;

FIG. 5 is a partly schematic sectional, top view showing the preferred embodiment; and

FIG. 6 is a schematic block diagram of the preferred embodiment.

### DETAILED DESCRIPTION OF THE PREFERRED EMBODIMENT

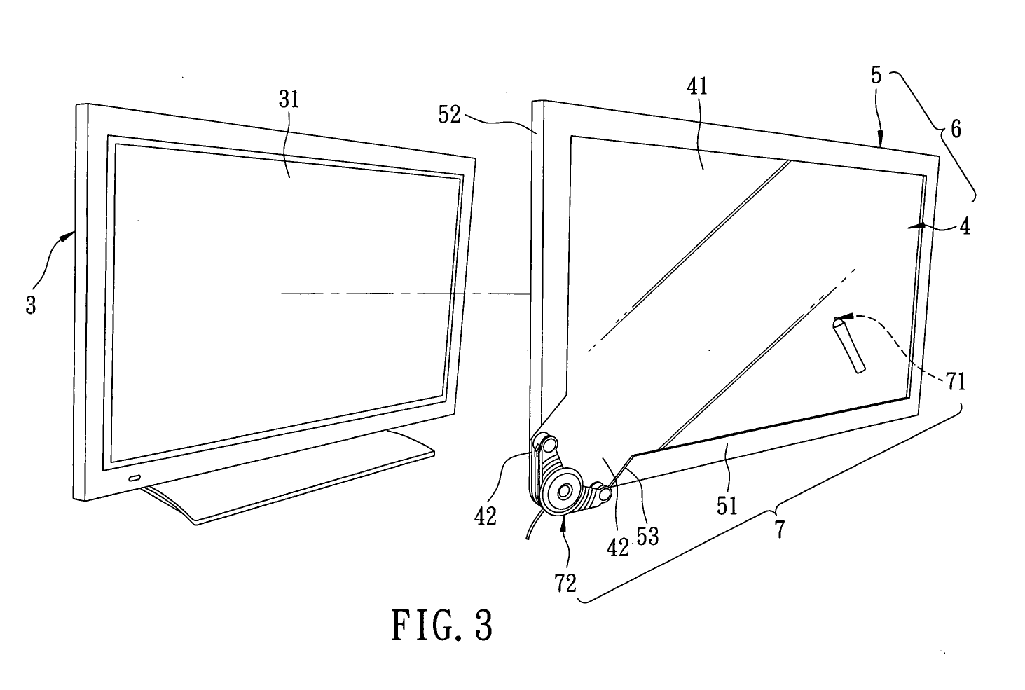

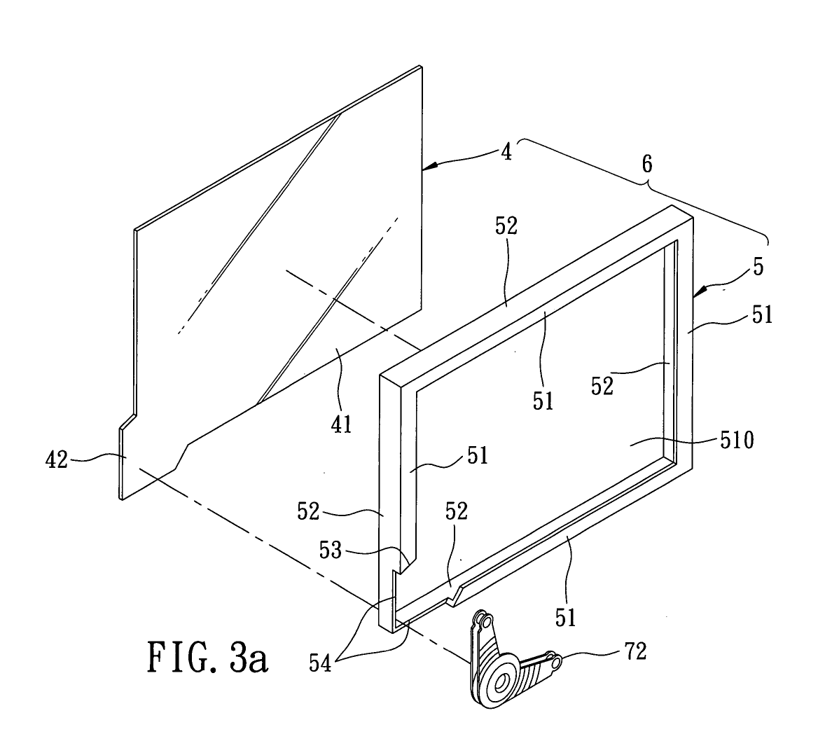

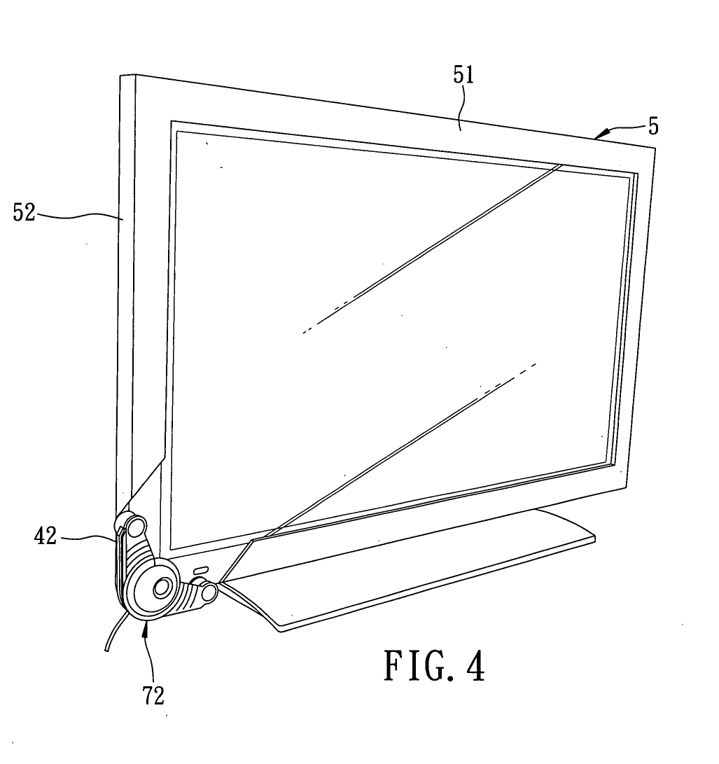

Referring to FIGS. 3, 4 and 6, the preferred embodiment of an electronic writing apparatus according to the present invention is shown to include a display unit 3, a transparent writing board 6, and a triangulation device 7.

The display unit 3, which is a liquid crystal display in this embodiment, has a display surface 31. The display unit 3 can also be a flat panel display (e.g., a flat panel television) or a plasma display (e.g., a plasma television).

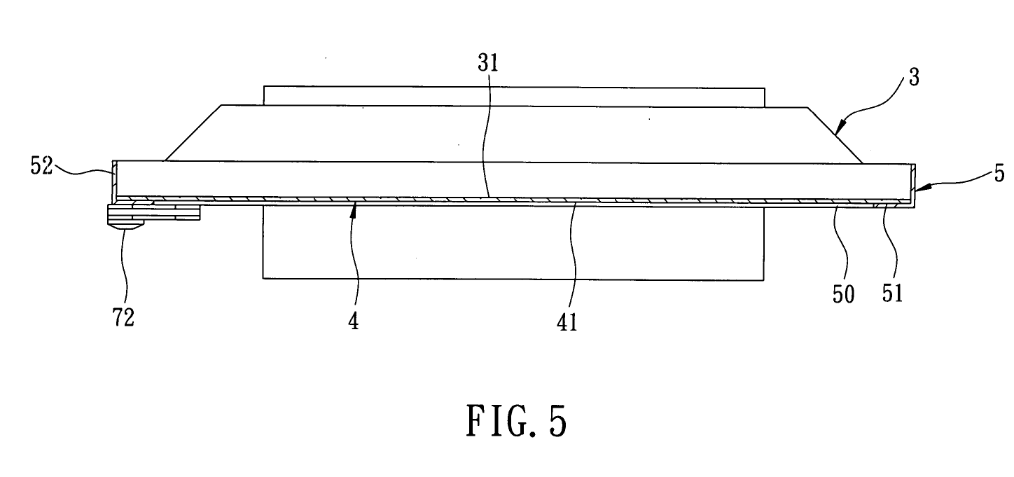

The writing board 6 is mounted in front of the display surface 31 of the display unit 3, and permits transmission of a light signal with a wavelength within a range from 400 nm to 700 nm therethrough. In this embodiment, the writing board 6 includes a rectangular transparent board 4 and a mounting frame 5. The transparent board 4 is made of a material selected from the group consisting of glass, acrylic and polycarbonate, and has a writing surface 41 distal from the display surface 31 of the display unit 3. The writing surface 41 of the transparent board 4 is formed with a mounting lug unit 42, as shown in FIG. 3a. The mounting frame 5 has a first frame body 51 confining a mounting hole 50 in which the transparent board 4 is mounted, and a second frame body 52 connected to and transverse to the first frame body 51 and mounted on a periphery of the display unit 3 such that the transparent board 4 covers the display surface 31 of the display unit 3, as shown FIG. 5. The second frame body 52 is formed with an engaging groove unit 54, which is an L-shaped groove in this embodiment, for engaging the mounting lug unit 42.

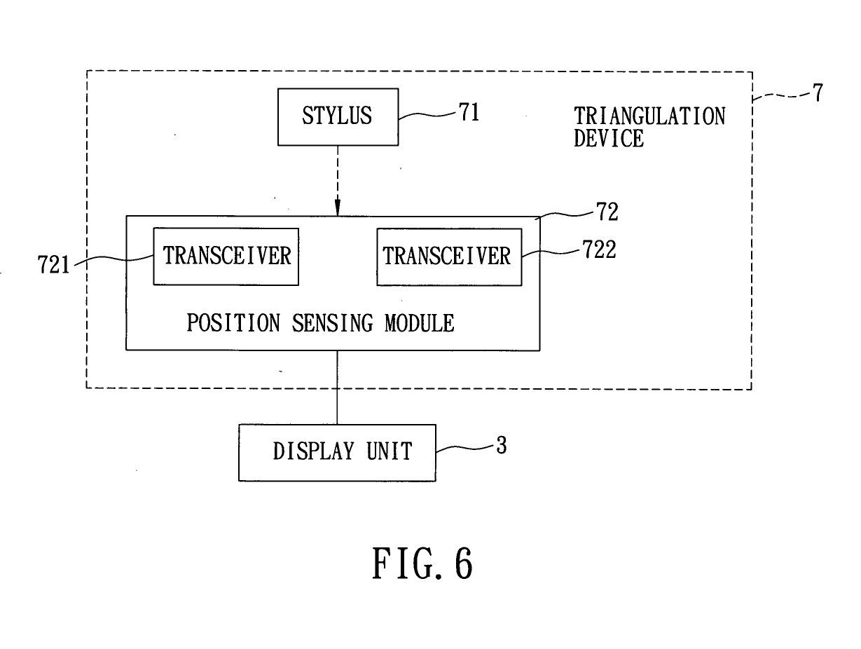

The triangulation device 7 includes a stylus 71 and a position sensing module 72. In this embodiment, the stylus 71 is operable so as to transmit an activating signal for activating the position sensing module 72 upon contacting the stylus 71 with the writing surface 41 of the transparent board 4. In this embodiment, the position sensing module 72 is disposed adjacent to a corner portion of the transparent board 4, and is retained on the mounting lug unit 42 in the writing surface 41 of the transparent board 4, as shown in FIG. 3. The position sensing module 72 is coupled to the display unit 3, and outputs an output signal associated with contact position information of the stylus 71 on the writing surface 41 to the display unit 3. As such, the display unit 3 generates an output image corresponding to writing trace of the stylus 71 on the writing surface 41 based on the output signal received from the position sensing module 72. In this embodiment, the position sensing module 72 includes two transceivers 721, 722 spaced apart from each other, as shown in FIG. 6. Each of the transceivers 721, 722 transmits a respective sensing signal, such as an electromagnetic wave signal and/or an ultrasonic wave signal, and subsequently receives the respective sensing signal reflected by the stylus 71 upon contacting the stylus 71 with the writing surface 41 of the transparent board 4. The output signal is obtained in accordance with the reflected sensing signals received by the transceivers 721, 722 in a known manner. The wavelength of the sensing signal transmitted by each of the transceivers 721, 722 is within a range from 800 nm to 1000 nm. Furthermore, the position sensing module 72 is capable of substantially filtering out a noise component of the reflected sensing signals received by the transceivers 721, 722 that has a wavelength within the range from 400 nm to 700 nm.

It is noted that the output signal outputted by the position sensing module 72 and associated with contact position information of the stylus 71 on the writing surface 41 can be further transmitted to an external computed for storage or compilation purposes or to a printer for printing.

The following are some of the advantages attributed to the electronic writing apparatus of the present invention:

1. Since the writing trace of the stylus 71 on the writing surface 41 can be displayed as an output image on the display unit 3 without the need for an inked writing pen used in the prior art, the electronic writing apparatus of this invention incurs relatively low operating costs.

2. Due to the presence of the triangulation device 7, contact position information of the stylus 71 on the writing surface 41 can be obtained without the need for a resistive membrane used in the prior art such that the electronic writing apparatus of this invention incurs relatively low fabrication costs.

3. Due to the presence of the transparent board 4, the electronic writing apparatus of this invention can provide a higher luminosity compared to the prior art with the resistive membrane.

4. Since the mounting frame 5 of the writing board 6 can match one of a flat panel television, a liquid crystal television and a plasma television as the display unit 3, the electronic writing apparatus of this invention is convenient and practical to use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electronic writing apparatus comprising:
a display unit having a display surface;
a transparent writing board mounted in front of said display surface of said display unit and having a writing surface distal from said display surface of said display unit, said writing board permitting transmission of a light signal with a wavelength within a range from 400 nm to 700 nm therethrough; and
a triangulation device including
a stylus, and
a position sensing module mounted on said writing surface of said writing board and coupled to said display unit, said position sensing module outputting an output signal associated with contact position information of said stylus on said writing surface to said display unit, said display unit generating an output image corresponding to writing trace of said stylus on said writing surface based on the output signal received from said position sensing module.

2. The electronic writing apparatus as claimed in claim 1, wherein said writing board includes a rectangular transparent board made of a material selected from the group consisting of glass, acrylic and polycarbonate.

3. The electronic writing apparatus as claimed in claim 2, wherein said writing board further includes a mounting frame that has a first frame body confining a mounting hole in which said transparent board is mounted, and a second frame body connected to and transverse to said first frame body and mounted on a periphery of said display unit such that said transparent board covers said display surface of said display unit.

4. The electronic writing apparatus as claimed in claim 3, wherein said position sensing module is disposed adjacent to a corner portion of said transparent board.

5. The electronic writing apparatus as claimed in claim 4, wherein said writing surface of said transparent board is formed with a mounting lug unit for retaining said position sensing module thereon.

6. The electronic writing apparatus as claimed in claim 5, wherein said second frame body is formed with an engaging groove unit for engaging said mounting lug unit.

7. The electronic writing apparatus as claimed in claim 1, wherein said position sensing module includes two transceivers spaced apart from each other, each of said transceivers transmitting a respective sensing signal and subsequently receiving the respective sensing signal reflected by said stylus upon contacting said stylus with said writing surface of said writing board, the output signal being obtained in accordance with the reflected sensing signals received by said transceivers.

8. The electronic writing apparatus as claimed in claim 7, wherein the wavelength of the sensing signal transmitted by each of said transceivers is within a range from 800 nm to 1000 nm.

9. The electronic writing apparatus as claimed in claim 8, wherein said position sensing module is capable of filtering out a noise component of the reflected sensing signals received by said transceivers that has a wavelength within the range from 400 nm to 700 nm.

10. The electronic writing apparatus as claimed in claim 1, wherein said stylus is operable so as to transmit an activating signal for activating said position sensing module upon contacting said stylus with said writing surface of said writing board.
